(19) United States
(12) Patent Application Publication
(10) Pub. No.: US 2008/0006683 A1
(43) Pub. Date: Jan. 10, 2008

(54) Information terminal device

(75) Inventor: Yasuhiko Abe, Niiza-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA

(21) Appl. No.: 11/515,286

(22) Filed: Sep. 1, 2006

(30) Foreign Application Priority Data
Jul. 10, 2006 (JP) 2006-189765

(51) Int. Cl. G06F 17/00

(52) U.S. Cl. 235/375

(57) ABSTRACT

It is determined whether key information is valid or invalid on the basis of first key management information indicating an expiration date of a terminal when a playback request for encoded content is input. When it is determined that the key information is invalid, an invalidation date of a key set in the first key management information with an encoding date of content stored in a recording medium. As the determination result, if an expression, encoding date<invalidation date is established, encoded content is determined to be legal content. On the contrary, if an expression, encoding date≧invalidation date, the encoded content is determined to be illegal content.

### CROSS-REFERENCE TO RELATED APPLICATIONS

This application is based upon and claims the benefit of priority from prior Japanese Patent Application No. 2006-189765, filed Jul. 10, 2006, the entire contents of which are incorporated herein by reference.

### BACKGROUND OF THE INVENTION

1. Field of the Invention

The present invention is related to an information terminal, for instance, a personal computer, a personal digital assistant (PDA), a portable audio player, etc., and more particularly to an information terminal device equipped with a content playback function.

2. Description of the Related Art

In recent years, as to an information terminal such as a notebook sized personal computer and a cellular phone, devices equipped with a function of playing back content received via a communication network or stored in a recording medium such as a memory card have become common. Using such an information terminal, a user can enjoy playing back content including favorite tunes and videos any where, and it is very convenient for the user.

To protect copyrights of the content, a variety of information terminals with a digital rights management (DRM) technique applied thereto have been examined. For instance, an information terminal acquires key information to encrypt the content from a rights server, encrypts the content on the basis of the key information to store it in a memory or a recording medium in the information terminal, and also stores the key information in a secure memory in the information terminal. When playing back the encoded content, the information terminal decrypts the encoded content on the basis of the key information stored in the secure memory to play back it. In this manner, the encoded content can be played back only by the information terminal (for example, refer to Jpn. Pat. Appln. KOKAI Publication No. 2005-141389).

However, in a device of this kind, the leakage of the key information enables any terminal to decrypt and play back the encoded content and enables the content to be copied illegally. Furthermore, the encoding of the played back content by using the leaked key information enables the content to be copied as a so-called pirated edition, and it is extremely disagreeable.

Therefore, a variety of countermeasures have been taking in account as follows.

(1) When the key information has leaked, the information terminal quickly re-encrypts the content, thereby it avoids decrypting the encoded content to prevent an illegal copy.

(2) With the leaked key information invalidated, the information terminal avoids playing back pirated edition content; thereby it stops the pirated edition content from being distributed.

However, to achieve these countermeasures, it is absolutely essential to establish a technique for accurately determining whether the content, encoded with the leaked key information, namely key information to be invalidated, is legal or illegal.

### BRIEF SUMMARY OF THE INVENTION

The present invention is invented by paying attention to the aforementioned situations, an object of the invention is to provide an information terminal device capable of accurately determining whether content encoded with key information to be invalidated is legal or illegal, thereby capable of effectively preventing an illegal copy of the content and a playback of illegal content.

According to an aspect of the present invention is as follows. That is, the information terminal stores the content encoded by using first key information and also stores information showing a date of encoding using the first key information by associating with the encoded content. Then, the information terminal determines whether the first key information is valid or invalid before playing back the encoded content. And if it is determined that the first key information is invalid, the information terminal compares information showing a date at which the first key information is invalidated with information showing a stored encoding date. As the comparison result, if the encoding date is before the invalidation date, the information terminal determines that the encoded content is legal content.

Accordingly, even if the first key information has leaked and the content has been copied by using the leaked first key information, if intending to play back the copied content, the information terminal compares the encoding date of the copied content with the invalidation date of the first key information which has been invalidated due to the leakage. Then, if the playback object is the copied content, the encoding date always becomes the date on and after the invalidation date. Therefore, the encoded content is determined to be the illegal content, and as a result, it becomes possible to prohibit the playback of the copied content. In contrast, if the information terminal intends to play back legal content, the encoding date becomes a date before the invalidation date. Accordingly, the encoded content is determined to be the legal content and as a result, the legal content becomes reproducible.

That is to say, an information terminal capable of accurately determining whether or not the content encoded with the key information to be invalidated due to the leakage, etc., thereby, capable of effectively providing the illegal copy of the content and the playback of the illegal content can be provided.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an exemplary schematic configuration view showing an embodiment of a system achieving a DRM in an information terminal device regarding the present invention;

FIG. 2 is an exemplary block diagram showing a configuration of a portable terminal used in the system shown in FIG. 1;

FIG. 3 is an exemplary flowchart showing a procedure and control content of key management control and content playback control by the portable terminal shown in FIG. 2;

FIG. 4 is an exemplary flowchart showing a procedure and processing content of determination processing of playback acceptance/rejection in the flowchart shown in FIG. 3;

FIG. 5 is an exemplary view for explaining a playback processing operation of legal content in the portable terminal shown in FIG. 2;

FIG. 6 is an exemplary view for explaining a playback processing operation of legal content in leaking key information in the portable terminal shown in FIG. 2;

FIG. 7 is an exemplary view for explaining removal processing operation of illegal content in leaking the key information in the portable terminal shown in FIG. 2;

FIG. 8 is an exemplary view for explaining a rewriting processing of terminal information and a playback processing operation of the legal content in the portable terminal shown in FIG. 2, and

FIG. 9 is an exemplary view for explaining the rewriting processing operation of the terminal information and the removal processing operation of the illegal content in the portable terminal shown in FIG. 2.

### DETAILED DESCRIPTION OF THE INVENTION

Hereinafter, embodiments of an information terminal device regarding the present invention with reference to the drawings.

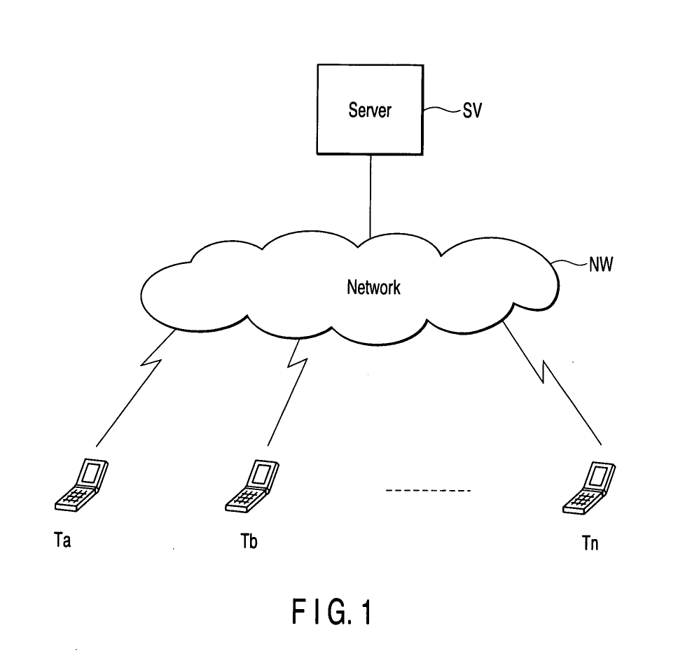

FIG. 1 is the exemplary schematic configuration view showing the embodiment of the system achieving the digital right management (DRM) in the information terminal device regarding the present invention. The system enables connecting a plurality of portable terminals Ta-Tn used as information terminal devices to a server SV via a communication network NW.

The server SV manages a plurality of items of unique key information for protecting copyright granted to content. The key information consists of a key itself and information indicating a status or a date. The status indicates any one of “unused”, “valid” and “invalid”. The date indicates an expiration date when the status is in “valid”, and indicates an invalidation date when the status is in “invalid”.

The server SV transmits the key information to the portable terminals Ta-Tn at request sources in response to, for instance, acquiring requests from the portable terminals Ta-Tn. The status of the key information transmitted at this moment is set to “valid”, the expiration date is set as the date. When invalidation requests of the key information transmitted to the portable terminals Ta-Tn are input by an operator using an input device of the server SV, the server SV changes the status of the corresponding key information from “valid” to “invalid” and further changes the expiration date to the invalidation date. The server SV then notifies information indicating the change content to the portable terminals Ta-Tn using the key information.

The communication network NW is composed of, for instance, an Internet protocol (IP) network and a plurality of access networks for accessing to the IP network. As for the access network, for example, a mobile communication network and a local area network (LAN) are used.

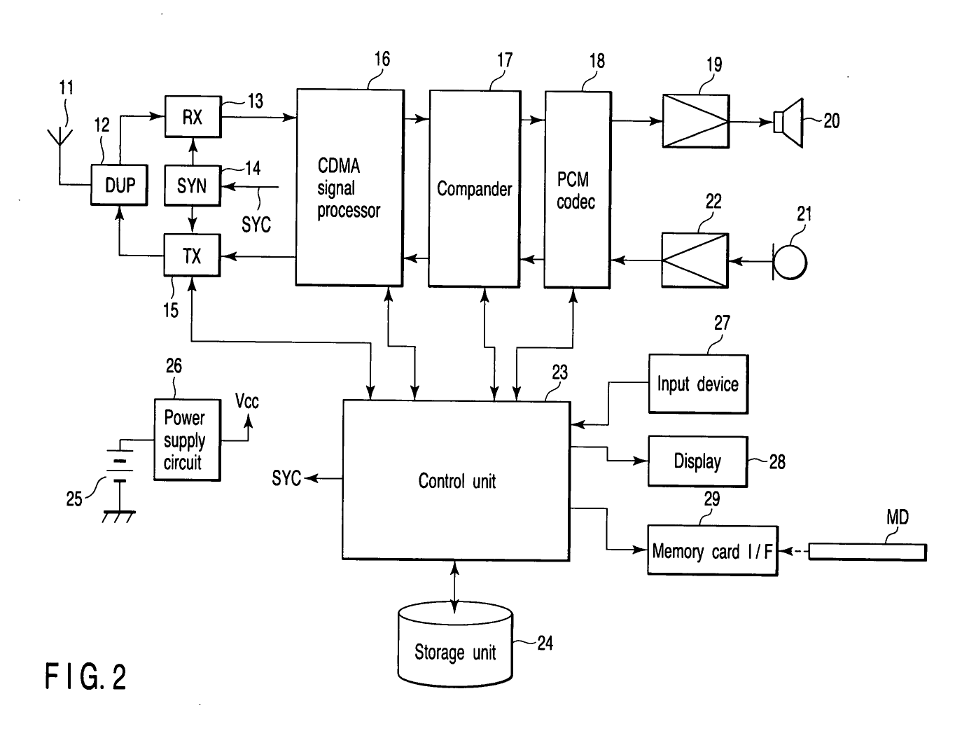

Meanwhile, the aforementioned portable terminals Ta-Tn are configured as follows. FIG. 2 is the block diagram showing the configuration.

A radio signal transmitted from a mobile communication base station (not shown) in the communication network NW is received by an antenna 11, then, input to a reception circuit (RX) 13 through an antenna duplexer (DUP) 12. The RX 13 mixes the received radio signal with a local oscillating signal output form a frequency synthesizer (SYN) 14 to down-convert it into an intermediate frequency signal. Each of the portable terminals Ta-Tn applies orthogonal demodulation the down-converted intermediate frequency signal to output a reception baseband signal. The frequency of the local oscillating signal generated from the SYN 14 is instructed by a control signal SYC output from a control unit 23.

The baseband signal is input to a code division multiple access (CDMA) signal processor 16. The CDMA signal processor 16 has a RAKE receiver. The RAKE receiver applies an inverse spreading processing a plurality of paths included in the reception baseband by spreading codes, respectively. After being arbitrated the phases of signals of each path with the inverse spreading processing applied thereto, the signals are synthesized. Thus, reception packet data in a prescribed transmission format is obtained. The reception packet data is input to a compressor/expander (hereinafter referred to as compander) 17.

When a telephone call mode has been set, the compander 17 decodes voice data included in the reception packet data output from the CDMA signal processor 16 by means of a speech codec to output a digital voice signal obtained by the decoding to a pulse code modulation (PCM) codec 18. The PCM codec 18 applies PCM decoding to the digital voice signal to output an analogue speech signal. The analogue speech signal is amplified by a reception amplifier 19 then output from a loud-speaker 20.

In contrast, when a download mode for the content and the key information is set, the compander 17 inputs encoded content data or the key information included in the reception packet data to the control unit 23. The control unit 23 stores the encoded content data or the key information in a storage unit 24 or a recording medium MD. The storage unit 24 is installed in the portable terminal and composed of a semiconductor memory having a hard disk or a non-volatile semiconductor memory. In contrast, the recording medium MD is composed of a NAND flash memory and detachably mounted onto a memory card interface 29.

On the other hand, in the telephone call mode, the voice signal of a speaker input to a microphone 21 is amplified by a transmission amplifier 22 up to an appropriate level, then, applied a PCM coding processing though the PCM codec 18, and made as a digital audio signal to be input to the compander 17. A video signal output from a camera (not shown) is digitized by the control unit 23 to be input in the compander 17.

The compander 17 detects an energy quantity of the input voice from the digital audio signal output from the PCM codec 18 to decide a transmission data rate on the basis of the detection result. The compander 17 then codes the digital audio signal into a signal in a format corresponding to the transmission data rate, thereby generates audio data. The compander 17 also codes the digital video signal output from the control unit 23 to generate video data. The compander 17 packetizes the audio data and the video data by a multiplexer/demultiplexer in accordance with a prescribed transmission format to output the transmission packet data to the CDMA signal processor 16. Even when a variety of items of request data has been output from the control unit 23, the compander 17 multiplexes the request data onto the transmission packet data.

The CDMA signal processor 16 applies a spectrum spreading processing to the transmission packet data output from the compander 17 by using spreading codes assigned to the transmission channel, then outputs its output signal to a transmission circuit (TX) 15. The TX 15 modulates the spectrum-spread signal by using a digital modulation system such as a quadrature phase shift keying (QPSK) system or a quadrature amplitude modulation (QAM) system. The CDMA signal processor 16 then synthesizes the transmission signal generated through the modulation with the local oscillating signal generated from the SYN 14 to frequency-convert it into a radio signal. The CEMA signal processor 16 performs high-frequency amplification to the radio signal so that it achieves a transmission power level instructed by the control unit 23. The amplified radio signal is supplied to the antenna 11 through the DUP 12 to be transmitted toward a base station from the antenna 11.

A display 28 displays video data of the played back content, index data of the content, information indicating an operation mode of a portable terminal, notice information of an incoming call and information indicating the remaining amount or a charging state of a buttery 25. A power supply circuit 26 generates a prescribed operation power supply voltage Vcc on the basis of the output from the buttery 25 to supply it to each circuit unit. The buttery 25 is charged by a charging circuit (not shown).

Meanwhile, the control unit 23 is composed of a micro computer, and has a key management control program, a legal/illegal determination program, a content re-encoding control section and a content playback control program as a new application program necessary for achieving the present invention.

The key management control program generates first key management information and second key management information, based on the key information acquired from the server SV. The first key management information manages the expiration date of the key information in the portable terminal and stored in the storage unit 24. The expiration date is set, for instance, to the same as the expiration date set by the server SV. Hereinafter, the first key management information is merely referred to as terminal information. The second key management information manages, for each item of key information, data (grant date) at which the content is encoded by using the key information and the use-by date of the corresponding key information, and stores it in the storage medium MD together with the encoding content. The key management control program updates the content of the first and the second key management information in response to the invalidation notice of the key information from the server SV and the passing of an occurrence of passing of the expiration date or the passing of the use-by date.

When a playback request for the encoded content is input, the legal/illegal determination program firstly determines the validity/invalidity of the key information on the basis of the first key management information. And in the case of invalidity, the determination program compares the invalidation date set to the first key management information with the encoding date set to the second key management information, if an expression encoding; date<invalidation date is satisfied, determines that the corresponding encoded content to be legal, and if an expression encoding; date≧invalidation date is satisfied, determines that the encoded content to be illegal.

When the encoded content to be played back is determined being the legal content by the legal/illegal determination program, the content encoding control section re-encrypts the encoded content on the basis of the spare key information which has been acquired from the server SV in advance. And when the playback request for the encoded content is input, the control section also compares a current date with the expiration date set to the first key management information. If the current date has exceeded the expiration date, in other words, when the expiration date of the key information has expired, the control section re-acquires the corresponding key information from the server SV to rewrite the first key management information (terminal information) on the basis of the re-acquired key information. If the rewritten key information has been invalidated, the control section re-encrypts the encoded content by using the spare key information required in advance.

When it is determined that the encoded content to be played back is legal content by means of the legal/illegal determination program, the content playback control program decodes and play backs the relevant encoded content. And on the contrary, when it is determined that the encoded content is illegal content, the control program prohibits the playback and re-encoding of the relevant encoded content. And in this case, the control program displays the message showing the impossibility of playing back the content onto the display 28.

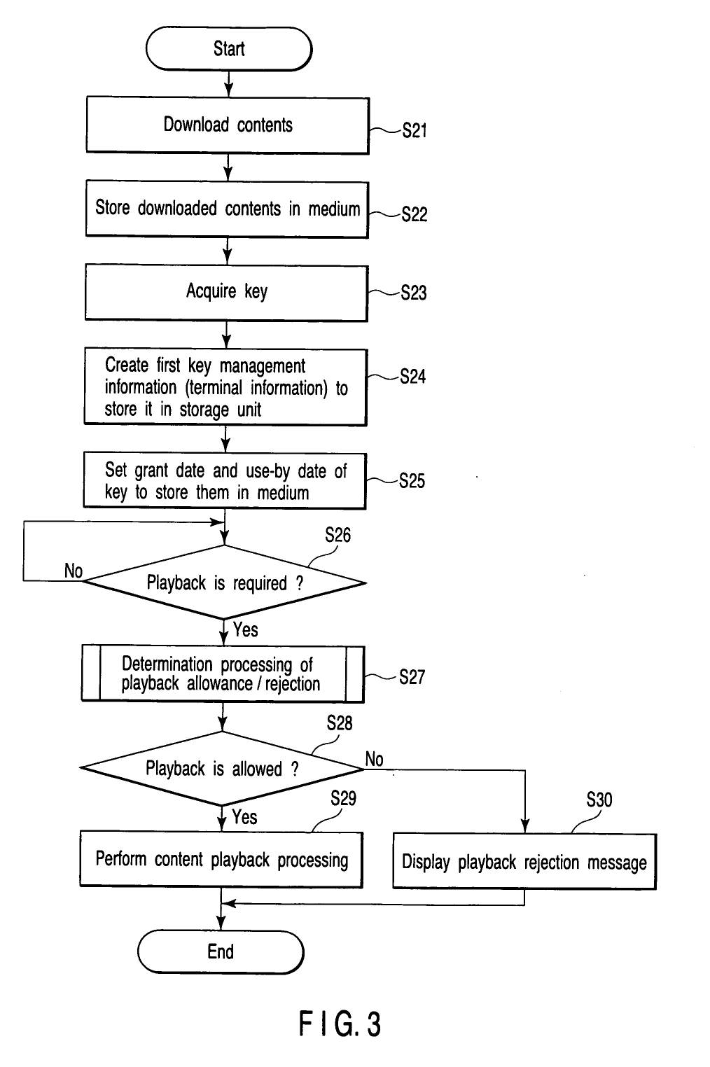

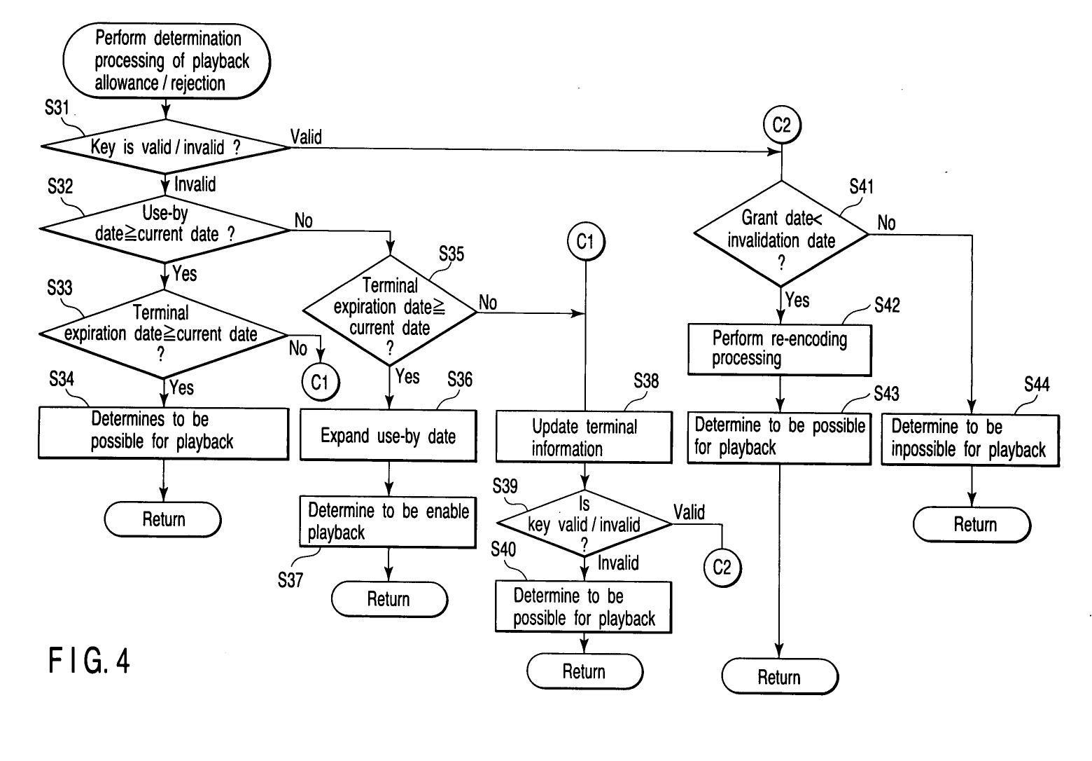

Next, a content playback processing by the portable terminal constituted as mentioned above will be described. Now, a portable terminal Ta will be explained as an example of the portable terminal. FIG. 3 is a flowchart showing its control procedure and control content, and FIG. 4 is a flowchart showing a processing procedure and processing content of playback acceptance/rejection determination in FIG. 3.

(1) Playback of Legal Content

In a step S21, the control unit 23 of the portable terminal Ta downloads desired encoded content α and in a step S22, it stores the downloaded encoded content α in the storage medium MD. Next to this, in a step S23, the control unit 23 acquires the key information used for encrypting the encoded content α from the server SV. The key information consists of the key itself and its expiration date.

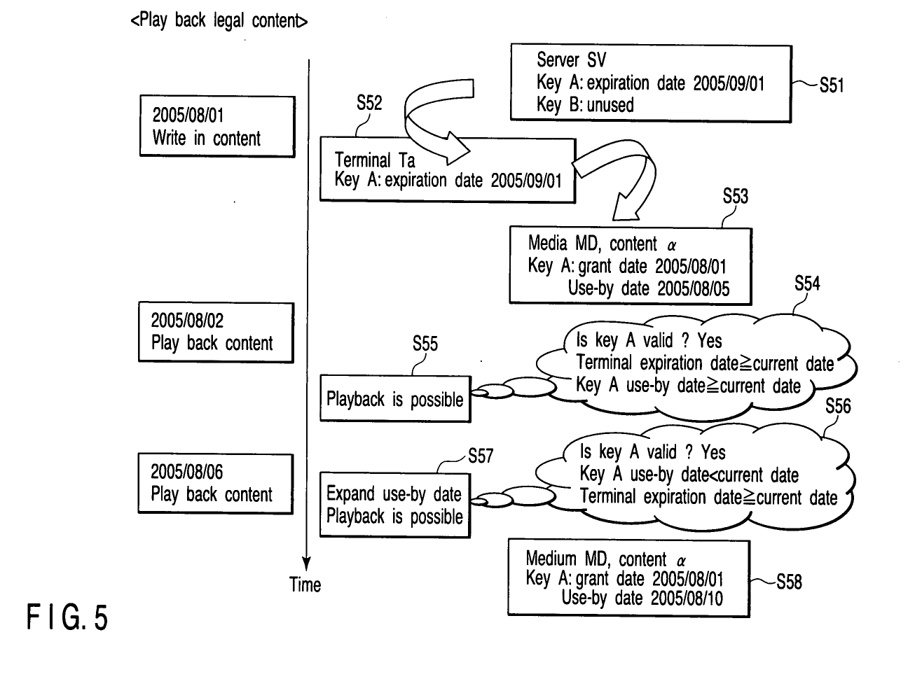

When acquiring the key information, in a step S24, the control unit 23 of the portable terminal Ta creates the first key management information (terminal information) on the basis of the acquired key information. The first key management information is the information showing the expiration date of the key in the self terminal (portable terminal) Ta. For instance, as shown at S51 in FIG. 5, it is presumed that the control unit 23 has acquired the key information composed of a key A and its expiration date “2005 Sep. 1” from the server SV. In this case, the portable terminal Ta, as shown at S52 in FIG. 5, sets the key A and its expiration date “2005 Sep. 1” as the first key management information (terminal information) as they are. The control unit 23 then stores this terminal information in the storage unit 24.

Sequentially, in a step S25, the control unit 23 creates second key management information to store in the storage medium MD by associating with the content. For example, it is supposed that the date at which the encoded content α was downloaded is “2005 Aug. 1”. In this case, the portable terminal Ta sets this download date as the encoding date “2005 Aug. 1” (grant date) of the content α. And the portable terminal Ta also sets the use-by date of the key A in the storage medium MD. The use-by date is set, for instance, to a date after four days from the current date. The control unit 23 associates the grant date and the use-by date which have been set like this with the content α as shown at S53 in FIG. 5 and stores them in the storage medium MD, as second key management information.

By the way, in such a situation, it is presumed that the user operates the input device 27 to input the playback request for the content α, for instance, at the date of “2005 Aug. 2” as shown in FIG. 5. The control unit 23 of the portable terminal Ta then detects the input of the playback request through a step S26 to shifts to a step S27, then, in the step S27, the control unit 23 executes the determination processing of the playback acceptance/rejection for the content α as follows.

In other words, at first, in a step S31, it is determined whether or not the key A corresponding to the content α to be played back is “valid” or “invalid”, based on the first key management information. As the determination result, if the key A is “valid”, sequentially, in a step S32, it is determined whether the use-by date of the key for the storage medium MD has been expired or not on the basis of the second key management information. The determination result, now, shows that the expression; use-by date (2005 Aug. 5)≧current date (2005 Aug. 2) is established, so that sequentially in a step S33, it is determined whether the expiration date of the key A in the portable terminal Ta has expired or not, based on the first key management information.

The result of the determination, now, shows that the expression; expiration date (2005 Sep. 1)≧current date (2005 Aug. 2), so that it determined that the content α can be played back through a step S34.

That is, as shown at S54 in FIG. 5, if the key A is “valid”, further conditions of use-by date≧current date and also expiration date≧current date are satisfied, the control unit 23 allows playing back the content α as at S55.

In contrast, as the result of the determination of the use-by date in the step S32, it is supposed that the use-by date in the storage medium MD has been expired. For instance, as shown at S56 in FIG. 5, the expression; use-by date (2005 Aug. 5)<current date (2005 Aug. 6) is established. In such case, the control unit 23, in step S35, determines whether or not the expiration date of the key A in the portable terminal Ta has been expired on the basis of the first key management information. The determination result now showing the expression; expiration date (2005 Sep. 1)>current date (2005 Aug. 6), the portable terminal Ta shifts to a step S36 to perform an expansion processing of the use-by date, then, allows playing back the content α (S57 in FIG. 5). For example, in FIG. 5, the control unit 23 expands the use-by date of the key A by five days, and as shown at S58, rewrites the second key management information.

Then, after completing the playback rejecting determination, the control unit 23 of the portable terminal Ta shifts to a step S28 as shown in FIG. 3, wherein the control unit 23 confirms whether the playback of the content α has been allowed or not in the aforementioned playback rejecting determination. If the playback has been allowed as described above, the control unit 23 shifts to a step S29, here it performs the decoding playback processing of the encoded content α.

For instance, if the encoded content is audio content, the control unit 23 reads out the content α from the storage medium MD then decodes it by using the key A, and supplies it to the compander 17. Then, after the audio content is expanded by the compander 17, it is converted into the analogue signal by the PCM codec, and after that, it is output from the loud-speaker 20 through the amplifier 19.

(2) Determination and Re-Encoding of Legal Content when the Key has Leaked

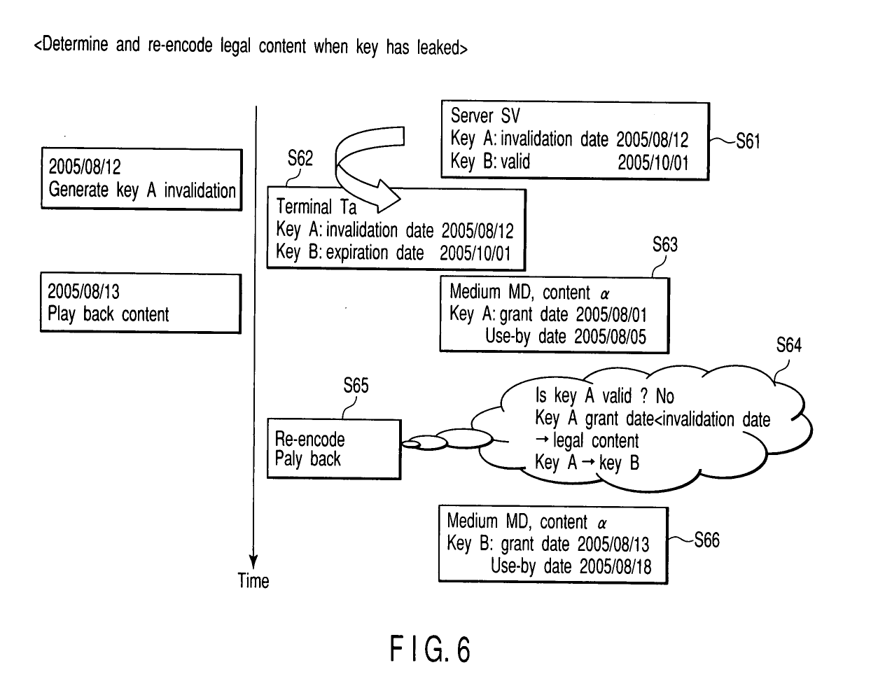

When it becomes clear that the key in use by the portable terminal Ta has leaked, then in the server SV, the status of the corresponding key is changed to “invalid” and the date is changed from the expiration date to the invalidation date. For example, as shown in FIG. 6, when the leakage of the key A becomes clear at the date of “2005 Aug. 12”, the server SV, as shown at S61, sets the invalidation date for the key A to the date of “2005 Aug. 12”. The server SV then sets the status of the spare key B to “valid” and also sets the expiration date to, for instance, the date of “2005/10/01”. Sequentially, the server SV notifies the changed key information to the portable terminal Ta being in use of the key A.

When the changed key information has been notified, the portable terminal Ta updates the first key management information on the basis of the changed key information. For example, as shown at S62 in FIG. 6, the portable terminal Ta brings the status of the key A into “invalid” to set its invalidation date 82005/08/12). And simultaneously, the portable terminal Ta newly registers the spare key B to set its expiration date. The second key management information is not changed here, as shown at S63 in FIG. 6.

In this situation, when the playback request for the content α is input, the control unit 23 of the portable terminal Ta implements the playback rejecting determination of the content α in accordance with the procedure shown in FIG. 4. That is, at first, the control unit 23 determines whether the key A is “valid” or “invalid” in the step S31, based on the first key management information. As the result of the determination, since the key A has been “invalid”, the control unit 23 shifts to the step S41, here compares the encoding data (grant date) to the aforementioned invalidation date of the content α by the key A. As the comparison result, in the case of FIG. 6, the expression; grant date (2005 Aug. 1)<invalidation date (2005 Aug. 12) is satisfied, so that as shown at S64, the control unit 23 presumes the content α to be the legal content and changes the key A to the key B. The control unit 23 then makes a shift to a step S42 to re-encrypt the content α with the key B, and in a step S43, it enables playing back the content α (S65 in FIG. 6). After completing the re-encoding, the control unit 23, as shown at S66 in FIG. 6, updates the second key management information stored in the storage medium MD into the content after the re-encoding.

Thus, even when the key A has leaked, if the content α to be played back is legal content, the content α become possible to be played back.

(3) Removal of Illegal Content when the Key has Leaked

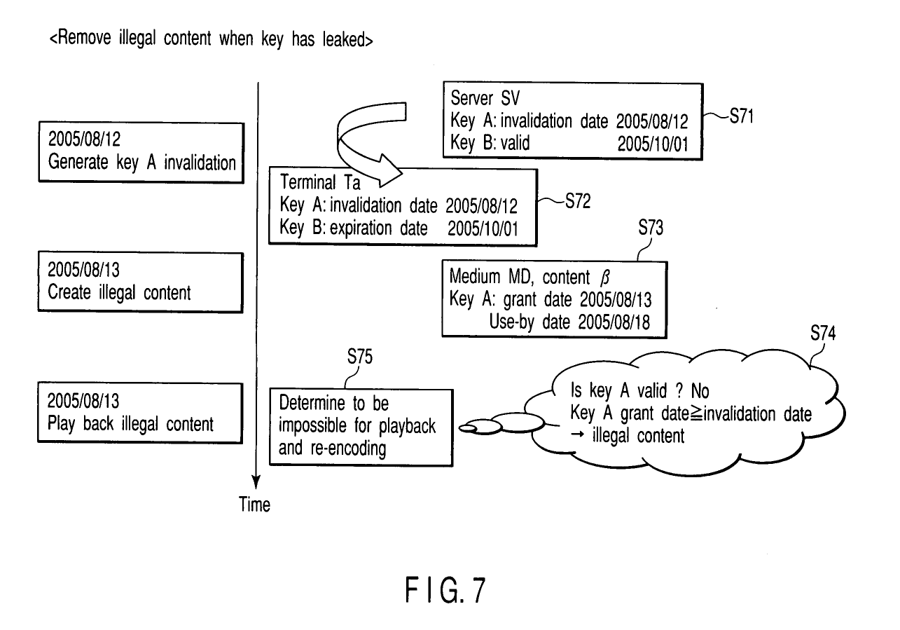

The processes, from making clear the leakage of the key to updating the first key management information by the portable terminal Ta in accordance with the notice from the server SV, is the same as those mentioned at the S61, S62 in FIG. 6 as shown at S71, S72 in FIG. 7.

Now, it is assumed that illegal content has been created by using the leaked key A. New content β encoded with the key A are stored in the storage medium MD. And at this moment, the control unit 23 creates second key management for the content β and stores the created second key management information in the storage medium MD. For instance, in FIG. 7, as shown at S73, the control unit 23 sets the date “2005 Aug. 13” at which the content β was encoded as a grant date, and further, it sets the use-by date of the key A for the storage medium MD to, for example, “2005 Aug. 13”.

When the playback request for the illegal content is input, the control unit 23 of the portable terminal Ta implements the playback rejecting determination of the content β in accordance with the procedure shown in FIG. 4. That is, at first, in the step S31, the control unit 23 determines whether the key A is “valid” or “invalid” on the basis of the first key management information. As the determination result, since the key A becomes “invalid”, the control unit 23 shifts to the step S41, where it compares the encoding date (grant date) to the invalidation date of the content β caused by the key A. Since the result of the comparison shows, in the case of FIG. 7, that the expression; grant date (2005 Aug. 13)≧invalidation date (2005 Aug. 12) is satisfied, as shown at S74, the control unit 23 presumes that the encoded content β to be illegal content, and in a step S44, it makes the content β impossible to be played back. At the same time, the control unit 23 also makes the content β impossible to be re-encoded. The control unit 23 shifts to the step S30 to generate a playback impossibility message to display it on the display 28.

Thus, even when the key A has leaked and the content has been copied by using the leaked key A, the corresponding content is surely removed as illegal content and the playback thereof is prevented. Accordingly, as a result, the distribution of the copied content is also prevented.

(4) Rewriting of Terminal Information and Determination and Re-Encoding of Legal Content

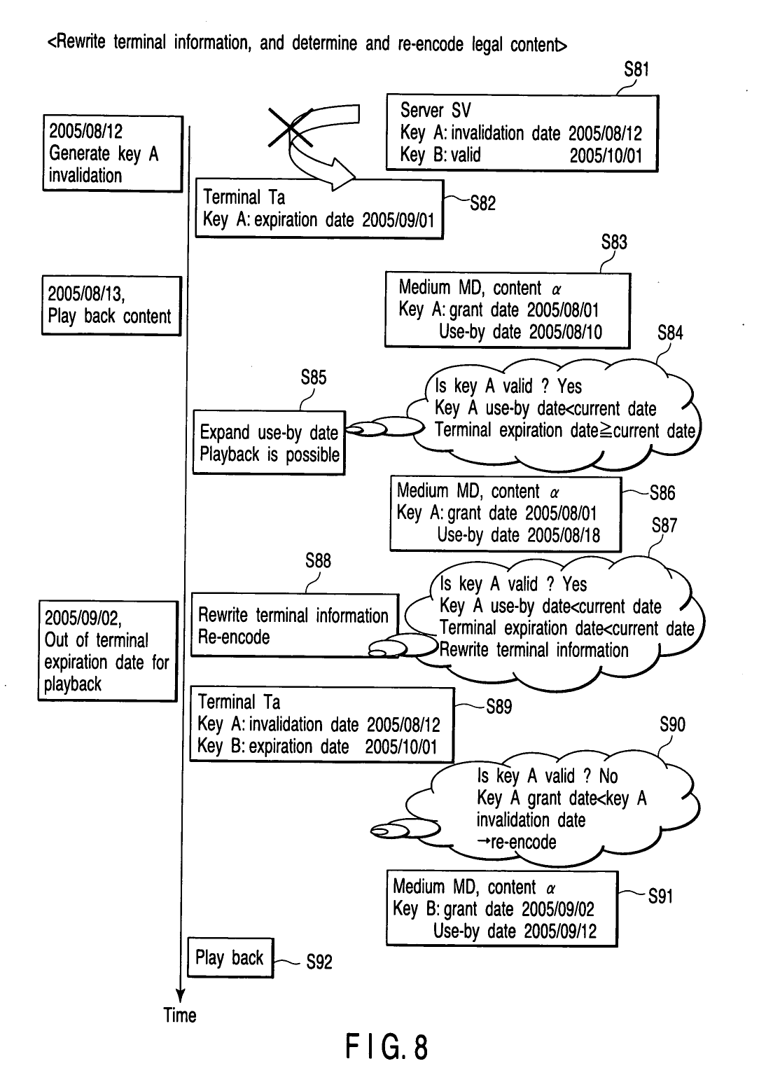

When a leakage of key information becomes clear, in the server SV, as shown at S81 in FIG. 8, the corresponding key information is invalidated and also spare key information is validated, and further, the invalidated key information and validated spare key information are notified to the portable terminal Ta.

However, there is some possibility that the invalidated key information and the validated spare key information will not approach the portable terminal Ta due to a failure, etc. in the communication network NW. In such a case, the portable terminal Ta, as shown at S82 in FIG. 8 does not update the first key management information indicating the expiration date of the key at the portable terminal Ta.

In this circumstance, it is supposed that the user inputs the playback request for the content α. The control unit 23 of the portable terminal Ta then, in the step S27, performs the determination of the playback allowance/rejection of the content α to be played back. In this determination, if the use-by date of the key A at the storage medium MD has not expired and also the expiration date of the key A at the portable terminal Ta has not expired, the control unit 23 can play back the encoded content α as it is as mentioned in (1). And as shown at S84 in FIG. 8, if only the use-by date has expired, as shown at S85 and S86, the control unit 23 can play back the encoded content α after performing the expansion processing of the use-by date of the key A.

On the contrary, as shown at S87 in FIG. 8, it is supposed that the expiration date of the key A at the portable terminal Ta has elapsed. In such a case, as shown in FIG. 4, the control unit 23 shifts to a step S38, here, it acquires the latest information relating to the key A from the server SV to update the first key management information on the basis of the acquired latest key information. For instance, as shown at S81 in FIG. 8, it is assumed that the key information acquired from the server SV has been invalidated for the key A and also the spare key information has been validated for the Key B, the first key management information are updated as it is into the content of the key information, as shown at S89.

Next, in a step S39, the control unit 23 determines the key A is “valid” or “invalid” on the basis of the forgoing updated first key management information. In this case, the key A has been invalidated. Therefore, the control unit 23 shifts to the step S41, here, it compares the encoding date (grant date) with the forgoing invalidation date of the content α by the key A. As the comparison result, in the case of FIG. 8, since the expression; grant date (2005 Aug. 1)<invalidation date (2005 Aug. 12) is established, the control unit 23 presumes that the content α to be legal content and changes the key A to the Key B. Then, the control unit 23 shifts to the step S42, here, after re-encrypting the content α with the spare key B as shown at S90 in FIG. 8, in the step S43, the control unit 23 enables playing back the content α. After completing the re-encoding, the control unit 23, as shown at S91 in FIG. 8, updates the second key management information stored in the storage medium MD into the content after the re-encoding.

As mentioned above, even in the case in which the control unit 23 cannot receive, from the server, the notice showing the fact of the invalidation of the key A at the time when it has been invalidated, the key information about the invalidated key is re-acquired from the server SV by the trigger of the elapse of the expiration date of the key A in the portable terminal Ta and the first key management information (terminal information) is updated. Then, the control unit 23 determines whether the content α is legal content or illegal content, based on the re-acquired key information, and if it is legal content α, the control unit 23 can play back the content α.

(5) Rewriting of Terminal Information, and Determination and Removal of Illegal Content

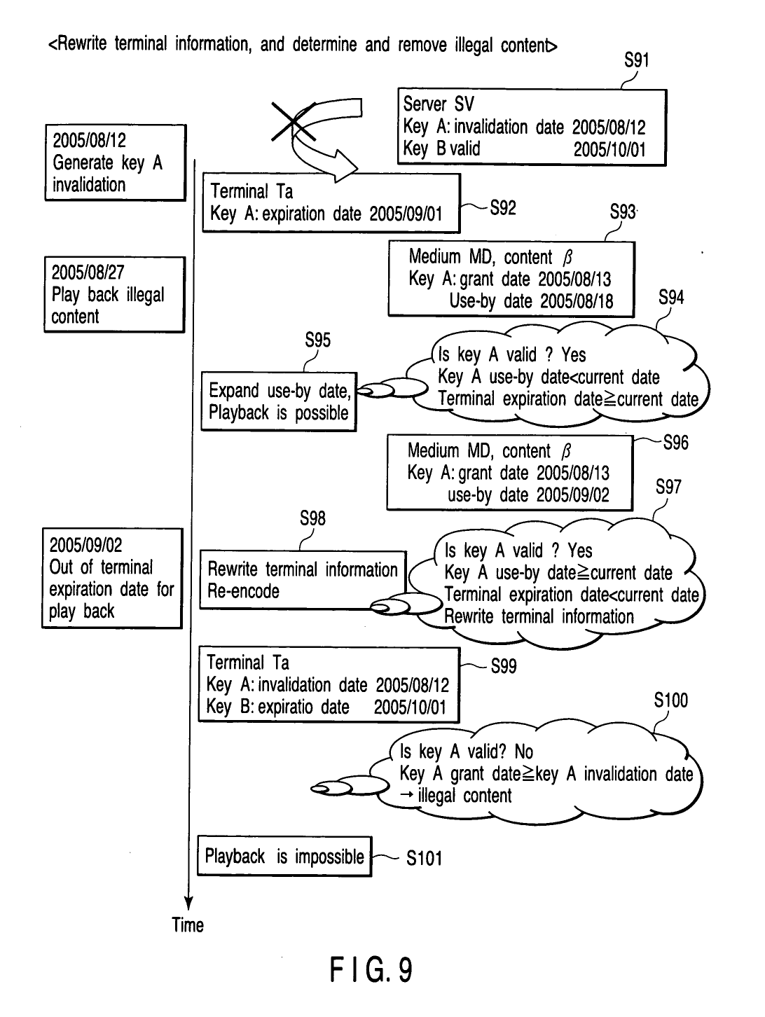

In a status where the invalidated key information transmitted from the server SV cannot be received, it is presumed that the illegal content β is created by using the invalidated key A and the playback request for the illegal content β are input. Under these circumstances, the first key management information has not been updated and the key A has been still “valid”. Therefore, the control unit 23 of the portable terminal Ta shifts from the step S31 to the step S32 to determined whether the use-by date of the key A at the storage medium MD has already expired or not. As the result of the determination, for instance, as shown at S94 in FIG. 9, if the use-by date has expired, the control unit 23, next, in a step S35, determines whether the expiration date of the key A of the portable terminal Ta has already expired or not. As the determination result, if the expiration date has not elapsed, in a step S36, the control unit 23 performs a processing to expand the use-by date, then, in a step S37, it enables the content β to be played back. In other words, the case like this results in playing back the illegal content β.

However, the status in which the illegal content β can be played back is limited within the expiration date of the key A, and it becomes impossible to be played back after the elapse of the expiration date. That is, it is supposed that the expiration date of the key A at the portable terminal Ta has expired as shown at S97 in FIG. 9. In such a case, the control unit 23 shifts to a step S38 shown in FIG. 4, and here, it acquires the latest information about the key A from the server SV to update the first key management information on the basis of the acquired latest key information. For instance, it is assumed that the key information acquired from the server SV shows that the key A has been invalidated and also the spare key B has been validated, as shown at the S91 in FIG. 9, the first key management information is updated as it is into the content of the foregoing key information as shown at the S99.

Sequentially, in the step S39, the control unit 23 determines whether the key A is “valid” or “invalid” on the basis of the updated first key management information. In this case, the key A has been invalidated. Therefore, the control unit 23 shifts to the step S41, and here, it compares the encoding data (grant date) by the key A with the forgoing invalidation date of the content β. And as the comparison result, in the case of FIG. 9, as shown at S100, since the expression; grant date (2005 Aug. 13)≧invalidation date (2005 Aug. 12) is satisfied, in a step S44, the content β is presumed to be illegal content. At the same time, the re-encoding of the content β is made impossible. In such circumstances, the control unit 23 shifts to the step S30 to create a playback disabled message to display it on the display 28.

Like this, even in the case that, at the time of invalidation of the key A, the control unit 23 cannot receive the notice showing the invalidation from the server SV, the control unit 23 re-acquires the invalidated key information from the server SV by the trigger of the elapse of the expiration date of the key A at the portable terminal Ta to update the first key management information (terminal information). The control unit 23 then determines whether the content α is legal content or illegal content on the basis of the re-acquired key information, and if the determination results shows that the content α is illegal content, the control unit 23 prohibits the playback and re-encoding thereof. Accordingly, even if the invalidated key information cannot be received from the server SV, the situation in which the illegal content is reproducible lasts semi permanently will be avoided.

As described above, in this embodiment, when the playback request for the encoded content is input, it is determined whether the key information is valid or invalid on the basis of the first key management information indicating the expiration date in the portable terminal. And if it is determined that the key information is invalid, the invalidation date of the key set to the first key management information is compared with the encoding date of the content stored in the storage medium MD. If the comparison result shows the expression; encoding date<invalidation date, the corresponding encoded content is determines to be legal content. In contrast, if the comparison result shows the expression; encoding date≧invalidation date, the encoded content is determined to be illegal content. Therefore, it is possible to determine whether the content encoded with the key information to be invalidated is legal or illegal. As a result, illegal copy of the content and the playback of illegal content can be effectively prevented.

At the time when the expiration date of the portable terminal is passed, the key information is re-acquired from the server SV and the first key management information is updated. The portable terminal then determines whether the content is legal or illegal on the basis of the updated first key management information. Therefore, even when the invalidation notice from the server SV has not been received at the time when the key A has been invalidated, it is determined whether the content is legal or illegal on the basis of the updated key management information. Accordingly, the failure of lasting semi permanently the state reproducible the illegal content can be prevented. Further, even when the content is determined to be legal, the content is re-encoded with the spare key B. That is, the renewability of the system can be secured.

The present invention is not limited to the above-mentioned embodiment. For instance, in the forgoing embodiment, at the time of the elapse of the expiration date of the key at the portable terminal, it re-acquires the key information form the server SV to update the first key management information. However, the present invention is not limited to this embodiment; the portable terminal may re-acquire the key information from the server SV at the time when the use-by date of the key stored in the storage medium MD has elapsed to update the first key management information. Thus, the portable terminal can update the first key management information at further short cycles, thereby; it can shorten the period of the state in which the illegal content is brought in a reproducible state.

The forgoing embodiment has been described while taking the case as an example, wherein the portable terminal acquires the already encoded content by downloading or from the storage medium to acquire its key information from the server. However, the portable terminal may acquire the content which has not been encoded yet and encrypt to store it on the basis of the key information acquired from the server.

Other than this, it is possible to make a variety of modifications to implement the configurations of the key, the encoding algorithms, the determination procedure of the playback allowance/rejection and its control content, and the kinds and configurations of the information terminal, etc., without departing from the aspect of the invention.

To put it briefly, the present invention is not limited to the aforementioned embodiments as they are, on an implementation phase, this invention may be embodied in various forms without departing from the inventive concept thereof. Various types of the inventions can be formed by appropriately combining a plurality of constituent elements disclosed in the foregoing embodiments. Some of the elements, for example, may be omitted from the whole of the constituent elements shown in the embodiments given above. Further, the constituent elements over different embodiments may be appropriately combined.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information terminal device, comprising:
a first memory configured to store content encoded by using first key information;
a second memory configured to store information indicating a date of encoding using the first key information by associating with the encoded content;
a section configured to acquire information indicating an invalidation date if the first key information has been invalidated;
a first determining section configured to determine whether the first key information is valid or invalid before playing back the encoded content;
a first comparison section configured to compare the information indicating the invalidation date of the first key information with the stored information indicating the encoding date if the first key information has been determined to be invalid; and
a second determining section configured to determine that the encoded content is legal content if the encoding date is before the invalidation date, based on a comparison result from the first comparison section.

2. The information terminal device according to claim 1, wherein the second determining section determines that the encoded content is illegal content if the encoding date is on and after the invalidation date, based on a comparison result from the first comparison section.

3. The information terminal device according to claim 1, further comprising:
a section configured to re-encode the encoded content by using second key information different from the first key information if the encoded content is determined to be legal content by the second determining section; and
a third memory configured to store information indicating a date of re-encoding using the second key information by associating with the re-encoded content.

4. The information terminal device according to claim 2, further comprising:
a section configured to inhibit playback and re-encoding of the encoded content if the encoded content is determined to be illegal content by the second determining section.

5. The information terminal device according to claim 1, further comprising:
a fourth memory configured to store information indicating an expiration date of the first key information;
a second comparison section configured to compare information indicating an expiration date of the stored first key information with information indicating a current date if it is determined that the first key information is valid by the first determining section;
a section configured to re-encode content encoded by a first encoding key by using second key information different from the first key information if the current date has exceeded the expiration date of the first key information as a comparison result from the second comparison section; and
a fifth memory configured to store information indicating a date of re-encoding using the second key information by associating with the re-encoded content.
